(19) United States
(12) Patent Application Publication
(10) Pub. No.: US 2016/0275345 A1
(43) Pub. Date: Sep. 22, 2016

(54) CAMERA SYSTEMS WITH ENHANCED DOCUMENT CAPTURE

(71) Applicant: Zhigang Fan, Webster, NY (US)

(72) Inventor: Zhigang Fan, Webster, NY (US)

(21) Appl. No.: 14/663,538

(22) Filed: Mar. 20, 2015

(51) Int. Cl. G06K 9/00

(52) U.S. Cl. CPC G06K 9/00442

(57) ABSTRACT

A method, a mobile image capturing device and a computer readable for capturing and processing both document and non-document images in optimized manners. The present invention contains steps:
a) determining if an image to be captured is a document image or a non-document image;
b) capturing and processing said image with methods and parameters optimized for document images if said determination is document;
c) capturing and processing said image with methods and parameters optimized for non-document images if said determination is non-document.

### CROSS-REFERENCE TO RELATED APPLICATION

This application hereby claims priority under 35 U.S.C. .sctn.119 to U.S. Provisional Patent Application No. 61/968,800 filed Mar. 21, 2014, entitled “Camera Systems with enhanced document capture,” the disclosure of which is incorporated herein by reference.

### TECHNICAL FIELD

Embodiments are generally related to mobile image capture methods and systems. Embodiments are further related to mobile image capture methods and systems with enhanced document image capture and processing.

### BACKGROUND OF THE INVENTION

With ever popular mobile image capture devices, such as mobile phone based cameras, they are more frequently used in capturing various kinds of documents, such as receipts, tickets, identification cards, magazine and book pages, Document images have significant differences in image characteristics than the natural pictures. For example, documents are often bi-tone or composed of a small number of different colors, while pictures may contain a much richer set of colors. Sharpness and text readability are emphasized in documents while color smoothness and naturalness are important for pictures. However, camera design is traditionally optimized for capturing natural pictures. As a result, document capture is often sub-optimal in terms of image quality and readability.

Thus, there is need for mobile image capturing devices, methods, and a computer readable medium for insuring image quality for capturing both natural (non-document) pictures and documents.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, an aspect of the disclosed embodiments to provide for a mobile image capture method and device that provide improved document image capture and processing without sacrificing non-document image capture and processing.

The aforementioned aspects and other objectives and advantages can now be achieved as described herein. A method, a mobile image capturing device and a computer readable for capturing and processing both document and non-document images in optimized manners. The present invention contains steps:

a) determining if an image to be captured by a mobile camera is a document image or a non-document image;

b) capturing and processing said image with methods and parameters optimized for document images if said determination is document;

c) capturing and processing said image with methods and parameters optimized for non-document images if said determination is non-document.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of an example mobile camera;

FIG. 2 illustrates a high-level flow chart depicting a method in accordance with an embodiment of a present teachings;

FIG. 3 illustrates a graph depicting a flow chart depicting an embodiment of automatic document/non-document classification.

FIG. 4 illustrates a graph depicting a flow chart depicting an embodiment of calculating the background features;

FIG. 5 illustrates a graph depicting a flow chart depicting an embodiment of calculating text features.

### DETAILED DESCRIPTION

This disclosure pertains to mobile image capturing devices, methods, and a computer readable for capturing document images in an improved manner. While this disclosure discusses a new technique for enhancing document capturing, one of ordinary skill in the art would recognize that the techniques disclosed may also be applied to other contexts and applications as well. The techniques disclosed herein are applicable to any number of electronic devices with digital image sensors, such as digital cameras, digital video cameras, mobile phones, personal data assistants (PDAs), portable music players, computers, and conventional cameras. A computer or an embedded processor that provides a versatile and robust programmable control device that may be utilized for carrying out the disclosed techniques.

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

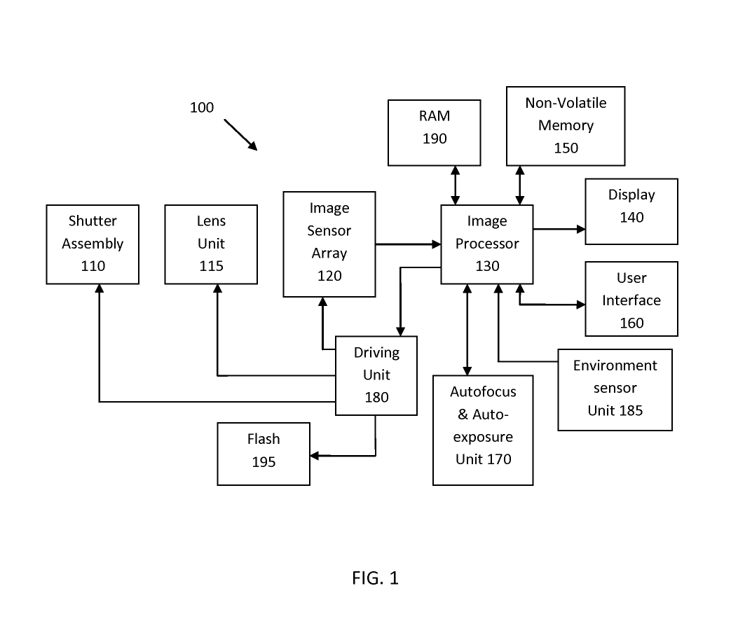

Referring now to FIG. 1, a block diagram of a mobile camera used to illustrate an example embodiment in which several aspects of the present invention may be implemented. Camera 100 is shown containing shutter assembly 110, lens unit 115, image sensor array 120, image processor 130, display 140, non-volatile memory 150, user interface 160, autofocus and auto-exposure unit 170, driving unit 180, environment sensor unit 185, RAM 190, and flash 190. Only the components as pertinent to an understanding of the operation of the example embodiment are included and described, for conciseness and ease of understanding. Each component of FIG. 1 is described in detail below.

Lens unit 115 may contain one or more lenses, which can be configured to focus light rays from a scene to impinge on image sensor array 120. Lens position can be adjusted to change its focus distance.

Image sensor array 120 may contain an array of sensors, with each sensor generating an output value representing the corresponding point (small portion or pixel) of the image, and proportionate to the amount of light that is allowed to fall on the sensor. The output of each sensor may be amplified/attenuated, and converted to a corresponding digital value (for example, in RGB format). The digital values, produced by the sensors are forwarded to image processor 130 for further processing.

Flash 195 provides additional illumination, particularly when ambient light is insufficient.

Shutter assembly 110 operates to control the amount of light entering lens enclosure 115, and hence the amount of light falling/incident on image sensor array 120. Shutter assembly 110 may be operated to control either a duration (exposure time) for which light is allowed to fall on image sensor array 120, and/or a size of an aperture of the shutter assembly through which light enters the camera. A longer exposure time would result in more amount of light falling on image sensor array 120 (and a brighter captured image), and vice versa. Similarly, a larger aperture size (amount of opening) would allow more light to fall on image sensor array 120, and vice versa.

Though the description is provided with respect to shutter assemblies based on mechanical components (which are controller for aperture and open duration), it should be appreciated that alternative techniques (e.g., polarization filters, which can control the amount of light that would be passed) can be used without departing from the scope and spirit of several aspects of the present invention. Shutter assembly 110 may be implemented in a known way using a combination of several of such technologies, depending on the available technologies (present or future), desired cost/performance criteria, etc.

Driving unit 180 receives digital values from image processor 130 representing exposure time, aperture size, gain value, lens position information, and flash on/off and converts the digital values to respective control signals. Control signals corresponding to exposure time and aperture size are provided to shutter assembly 110, control signals corresponding to gain value are provided to image sensor array 120, control signals corresponding to flash on/off are provided to flash 190, while control signals corresponding to lens position are provided to lens assembly 115. It should be understood that the digital values corresponding to exposure time, aperture size, gain value, flash on/off and lens position represent an example configuration setting used to configure camera 100 for a desired brightness. However, depending on the implementation of shutter assembly 110, lens unit 115, and design of image sensor array 120, additional/different/subset parameters may be used to control the shutter assembly and lens unit as well.

Autofocus and auto-exposure unit 170 determines the lens position and the exposure setting. In determining the lens position, an object to camera distance is often implicitly estimated. The unit could be a software module physically residing in the image processor 130.

Display 140 displays an image frame in response to the corresponding display signals received from image processor 130. Display 140 may also receive various control signals from image processor 130 indicating, for example, which image frame is to be displayed, the pixel resolution to be used etc. Display 140 may also contain memory internally for temporary storage of pixel values for image refresh purposes, and is implemented in an embodiment to include an LCD display. Display 140 may also contain multiple screens.

User interface 160 sends signals, instructions, warnings, and feedbacks to users. It also provides users with the facility of inputs, for example, to select features such as whether auto exposure and/or autofocus are to be enabled/disabled. The user may be provided the facility of any additional inputs, as described in sections below.

Environment sensor unit 185 is composed of various sensors that provide environment information before or when the image is captured. In particular, the sensor unit may contain an accelerometer and a gyroscope. The accelerometer and gyroscope readings may provide the information about the camera orientation.

RAM 190 stores program (instructions) and/or data used by image processor 130. Specifically, pixel values that are to be processed and/or to be user later, may be stored in RAM 190 by image processor 130.

Non-volatile memory 150 stores image frames received from image processor 130. The image frames may be retrieved from non-volatile memory 150 by image processor 130 and provided to display 140 for display. In an embodiment, non-volatile memory 150 is implemented as a flash memory. Alternatively, non-volatile memory 150 may be implemented as a removable plug-in card, thus allowing a user to move the captured images to another system for viewing or processing or to use other instances of plug-in cards.

Non-volatile memory 150 may contain an additional memory unit (e.g. ROM, EEPROM, etc.), which store various instructions, which when executed by image processor 130 provide various features of the invention described herein. In general, such memory units (including RAMs, non-volatile memory, removable or not) from which instructions can be retrieved and executed by processors are referred to as a computer readable medium.

Image processor 130 forwards pixel values received to enable a user to view the scene presently pointed by the camera. Further, when the user “clicks” a button (indicating intent to record the captured image on non-volatile memory 150), image processor 130 causes the pixel values representing the present (at the time of clicking) image to be stored in memory 150.

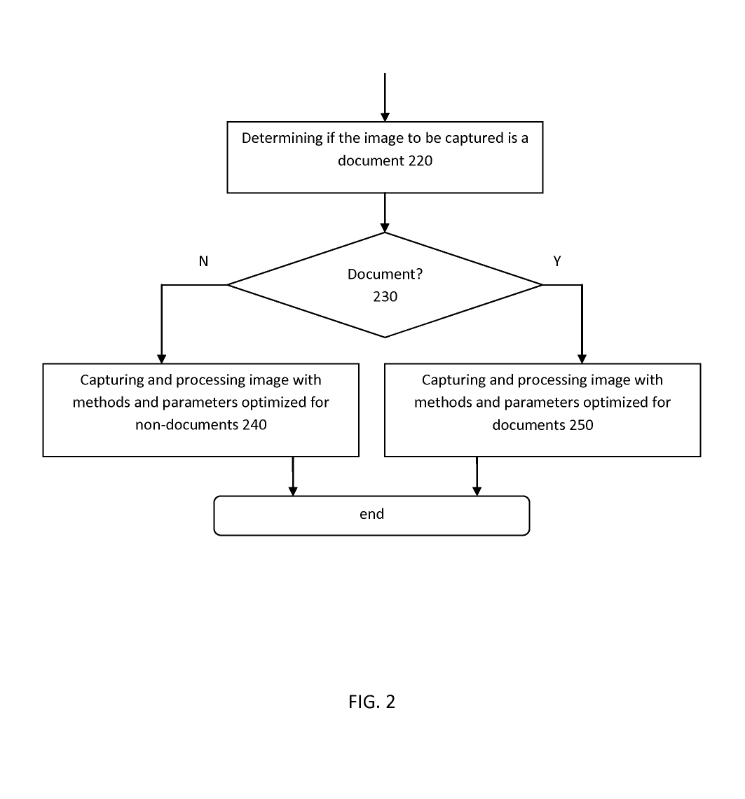

Referring now to FIG. 2, a flow chart depicting a method in accordance with an embodiment of a present teachings. In Block 210, it is determined whether the image to be captured is a document image. The determination can be accomplished with various methods. In one embodiment of the present invention, a preview image is captured and is classified with an automatic document detection method. The automatic document detection/classification will be further described later more in detail. In a second embodiment of the present invention, the user sets a “document” mode through the user interface 160 and the images to be captured under the document mode are considered to be documents. In another embodiment of the present invention, an mobile device application (“app”), for example a barcode detection or OCR (optical character recognition) app, sets the “document” mode and the images to be captured under the document mode are considered to be documents. In yet another embodiment of the present invention, the image classification is determined in a semi-automatic manner. An automatic document detection is first performed. If there exists any uncertainty in detection, the user is prompted to confirm or reject the results. If the image is classified as non-document (no in block 230), the image is captured and processed for optimizing picture capture, for example by the conventional methods (block 240). On the other hand, if the image is classified as document (yes in block 230), the capturing and processing methods, algorithms, and associated parameters are optimized for document images (block 250). This includes but is not limited to enhancement of text, enhancement of background, automatic white balance optimized for documents, local tone mapping optimized for documents, flash and exposure adjustment optimized for documents, and geometrical distortion correction. This may include a segmentation procedure that separates background, text and other objects in the document and process them separately, for example for text enhancement and background enhancement. It may also include other processing and enhancement algorithms that do not require segmentation, for example local tone mapping and automatic white balance. The segmentation can be accomplished by known methods such as method disclosed in US patent of Fan, “Background-Based Image Segmentation”, disclosed in U.S. Pat. No. 6,973,213, the contents of which is incorporated herein by reference, the method disclosed in US patent of Ancin, “Document segmentation system”, disclosed in U.S. Pat. No. 5,956,468, the contents of which is incorporated herein by reference.

Enhancement of text may include sharpening, contrast enhancement, and/or tone-adjustment. This can be accomplished by many known methods. For example, the text can be sharpened with high-pass filtering. The contrast and tone is adjusted to increase the contrast between the text with their background. For example, for blue text with white background, the text would be adjusted towards darker blue. For text of light gray with black background, the text would be adjusted towards brighter gray. The adjustment is mainly in luminance, but not limited to luminance.

The enhancement of background may include tone-adjustment (typically make brighter color background brighter), color adjustment (typically make it closer to neutral color) and noise (including flash spot and shadow) removal/reduction. This can also be accomplished by many known methods. In one embodiment of the present invention, a “current background color” is first estimated as the average pixel colors for all pixels that are classified as background. It is then determined whether the image has a white background by comparing the “current background color” to white color. If the color difference, for example a weighted Euclidean distance is smaller than a pre-determined threshold, the image is assumed to have a white background, and a “desired background color” is set to white. Otherwise, the image is assume to have a non-white background, and the “desired background color is set to the “current background color”. The background pixel colors are then adjusted as:

c2(x,y)=w d+(1−w)c1(x,y),

where c1 (x, y) and c2 (x, y) are the color of pixel at (x, y) before and after adjustment, w is a predetermined weight (in the range of 0 and 1), and d is the “desired background color”.

Automatic white balance exists in most mobile based cameras. It adjusts colors globally based on an estimation of the illumination color, or white point. For documents, the adjustments may exploit the knowledge that most documents have a white background and black text. In one embodiment of the present invention, a “current background color” is first estimated as the average pixel colors for all pixels that are classified as background. It is then determined whether the image has a white background by comparing the “current background color” to white color. If the image is determined to have a white background, the “current background color” can be used as the estimated white point. Otherwise, a conventional AWB method is applied.

Local tone mapping is another function existing in many mobile based cameras. It adjusts brightness locally in an attempt to boost local contrast. For documents, the adjustments may exploit the knowledge that most documents are bi-tone or composed of a limited number of different colors. As the traditional local tone mapping may enhance noise in uniform regions, in one embodiment of the present invention, the local tone mapping is bypassed for document images.

A too strong flash light with over-exposure may leave a bright spots on the image, which may eliminate text and other important information in a document image. If a flash light needs to be applied for capturing a document image, over-exposure should be avoid. The optimal flash strength/duration and exposure setting may be determined by an off-line calibration process. During calibration, document images are placed with difference distances and under different ambient illumination levels. The optimized flash strength/duration and exposure settings are stored for each case. During image capture, the object to camera distance and the ambient light level are obtained from autofocus and auto-exposure unit 170. The stored optimal flash strength/duration and exposure settings are applied, based on the object distance and ambient illumination levels.

A document image may contain various geometrically distortions, including perspective distortions and warping. The distortions are often originated from an imperfect camera position and/or uneven document surfaces. Various known methods for geometrical distortion correction exist that can be applied here, such as method disclosed in US patent of Ma, “Method and system for correcting projective distortions with elimination steps on multiple levels”, disclosed in U.S. Pat. No. 8,811,751, the contents of which is incorporated herein by reference, the method disclosed in US patent of Ma, “Method and system for correcting projective distortions using eigenpoints”, disclosed in U.S. Pat. No. 8,913,836, the contents of which is incorporated herein by reference.

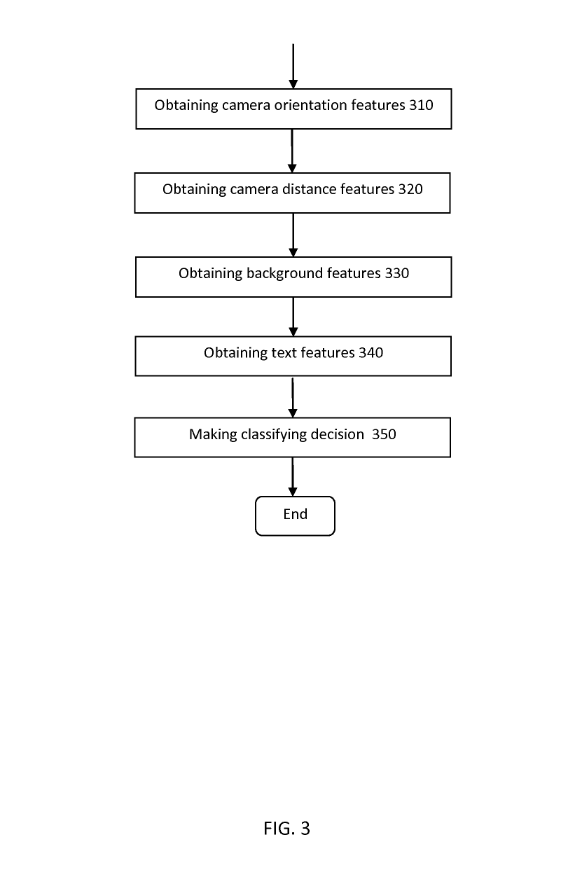

Referring now to FIG. 3, a flow chart depicting an embodiment of automatic document/non-document classification. The classification is based on a set of features, which include the camera orientation, object to camera distance, and image content features. The image content features may further contain background features and text features. In block 310, the camera orientation is obtained from the environment sensor unit 185. For capturing a document, the camera orientation is more likely facing downwards. In block 320, the object to camera distance is obtained from autofocus and auto-exposure unit 170. For capturing a document, the camera is typically placed to a relatively short distance (e.g. less than one meter) from the document. If the object to camera distance is relatively large, say more than 2 meters, it is more likely not a document. A document image is typically composed of a background that contains text and other objects, such as pictures and graphics. In block 330, the background is detected, and its features are extracted. The features include but are not limited to background color, background color uniformity, background size, and background border shape. In block 340, the text characters are detected, and a set of text features are extracted. The features may include number of text objects in the image, text color and distribution, text size and distribution, text stroke thickness, and text line structure. In block 350, a classification decision is made by combining all the feature information obtained from blocks 310 to 340. Many known classification methods such as neural net, Bayesian classifier, and Support Vector Machine can be applied here.

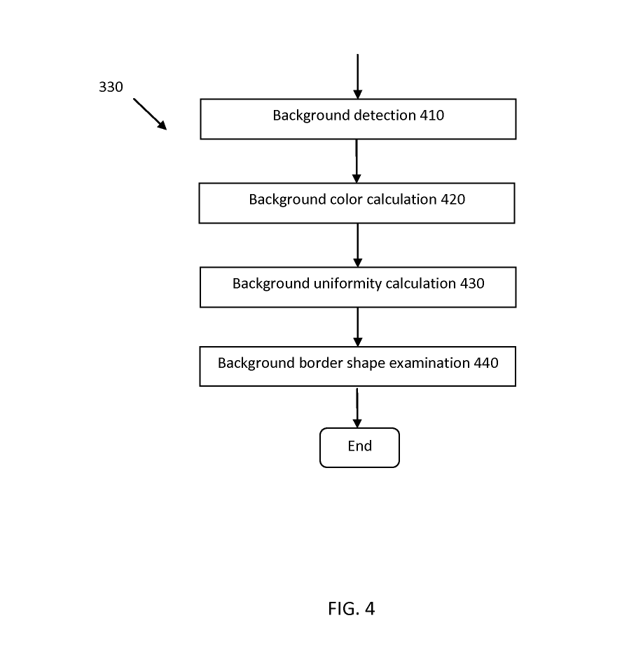

Referring now to FIG. 4, a flow chart depicting an embodiment of extracting background features. In block 410, the background in the image is detected. This can be accomplished by many known methods, such as method disclosed in US patent of Fan, “Background-Based Image Segmentation”, disclosed in U.S. Pat. No. 6,973,213, the contents of which is incorporated herein by reference, the method disclosed in US patent of Ancin, “Document segmentation system”, disclosed in U.S. Pat. No. 5,956,468, the contents of which is incorporated herein by reference.

The average color and color uniformity (measured for example by color variance) of the detected background are calculated in blocks 420 and 430, respectively. A bright and uniform color is more likely to be the background. In block 440, the border shape of the detected area is examined. A physical document typically has a rectangular shape. When captured by a camera, the border of the rectangle would either become invisible in the image (if the image contains only the interior part of the document), or become straight lines (or curves close to straight lines if the page is not flat). If the border of the detected areas has a shape that is significantly deviated from that (for example, the detected area has a circular shape), the detected area is not likely to be the background of a document.

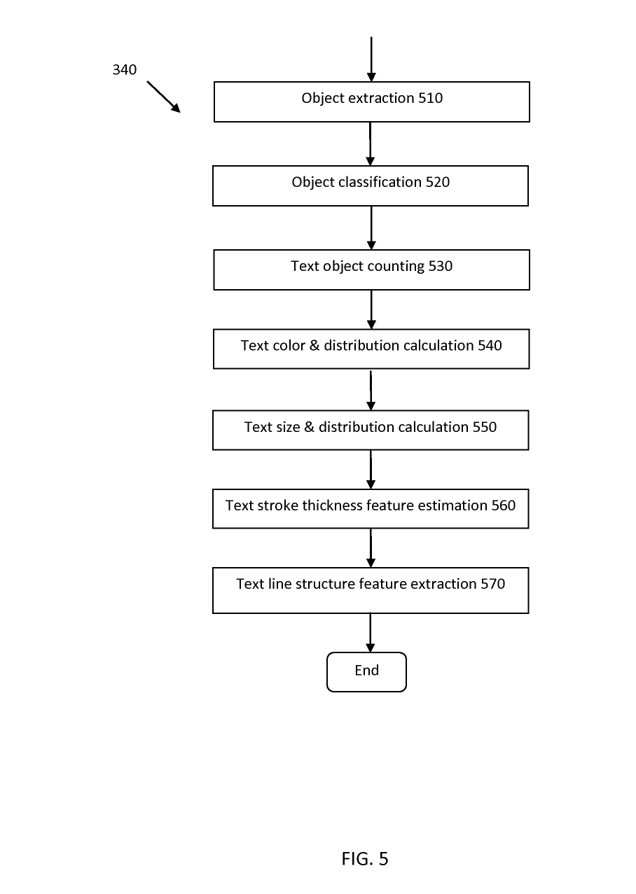

Referring now to FIG. 5, a flow chart depicting an embodiment of extracting text features. In block 510, objects that are surrounded by the background pixels are extracted. This can be accomplished by for example connected component analysis. The extracted objects are classified as text objects and other objects in block 520, based on their dimensions and their brightness values. An object whose height and width fall in a pre-determined range and its color is darker than a pre-determined threshold is classified as text object. This pre-determined range can be adjusted based on the camera distance. The number of text objects is counted in block 530. The dominant text sizes and their distributions, the dominant text colors and their distributions are calculated in blocks 540 and 550, respectively. The text stroke thickness is estimated in block 560. This can be performed with known methods, or be approximated by calculating the median run-length. The stroke thickness or run-length, relative to the object dimension, is typically smaller for text than for non-text objects. The text in a document usually forms lines. The existence of the line structure is an indication of documents. In block 570, the line structure is detected. This can be accomplished by examining the horizontal and vertical profiles of the pixels that are classified as text. Specifically, horizontal and vertical profiles h(x) and v(y) are calculated as

v(y)=sumₓ[t(x,y)]

and

h(x)=sum_{y}[t(x,y)],

respectively, where
t(x, y)=1, if pixel (x, y) belong to a text object
t(x, y)=0, otherwise.
   The profiles are examined to see if strong peaks (high counts) and valleys (low counts) exist, which represent the text lines and the blank spaces between the lines, respectively. In one embodiment of the present invention, the confidence of existence of the line structure is measured by L2 norms of the two profiles, specifically, the maximum of vertical profile L2 norm and horizontal profile L2 norm, normalized by the total number of text pixels.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for performing image capture in a mobile device, the method comprising:
a) determining if an image to be captured is a document image or a non-document image;
b) capturing and processing said image with methods and parameters optimized for document images if said determination is document;
c) capturing and processing said image with methods and parameters optimized for non-document images if said determination is non-document.

2. The method of claim 1, wherein said document determination further comprises:
automatic document classification;
automatic document classification with user confirmation;
user input; or
application program input.

3. The method of claim 1, wherein said capturing and processing image with methods and parameters optimized for document images further comprises at least one procedure of:
segmentation of image;
enhancement of text;
enhancement of background;
automatic white balance optimized for documents;
local tone mapping optimized for documents;
flash and exposure adjustment optimized for documents; and
geometrical distortion correction.

4. The method of claim 2, wherein said automatic document classification further comprises:
obtaining camera orientation features;
obtaining camera distance features;
obtaining background features;
obtaining text features;
making classification decision based on at least one of said camera orientation, camera distance, background and text features.

5. A mobile image capture device for capturing an image, said mobile image capture device comprising:
a lens unit;
an image sensor designed to generate a plurality of sets of pixel values;
a user interface enabling sending warning signals and receiving user inputs;
a camera distance determination unit;
a camera orientation determination sensor;
a flash light;
an image processor designed for:
a) determining if an image to be captured is a document image or a non-document image;
b) capturing and processing said image with methods and parameters optimized for document images if said determination is document;
c) capturing and processing said image with methods and parameters optimized for non-document images if said determination is non-document.

6. The mobile image capture device of claim 5, wherein said document determination further comprises:
automatic document classification;
automatic document classification with user confirmation;
user input; or
application program input.

7. The mobile image capture device of claim 5, wherein said capturing and processing image with methods and parameters optimized for document images further comprises at least one procedure of:
segmentation of image;
enhancement of text;
enhancement of background;
automatic white balance optimized for documents;
local tone mapping optimized for documents;
flash and exposure adjustment optimized for documents; and
geometrical distortion correction.

8. The mobile image capture device of claim 6, wherein said automatic document classification further comprises:
obtaining camera orientation features;
obtaining camera distance features;
obtaining background features;
obtaining text features;
making classification decision based on at least one of said camera orientation, camera distance, background and text features.

9. A non-transitory program storage device residing in a mobile image capture device, readable by a programmable control device comprising instructions stored thereon for causing the programmable control device to:
a) determine if an image to be captured is a document image or a non-document image;
b) capture and process said image with methods and parameters optimized for document images if said determination is document;
c) capture and process said image with methods and parameters optimized for non-document images if said determination is non-document.

10. The non-transitory program storage device of claim 9, wherein said document determination further comprising:
automatic document classification;
automatic document classification with user confirmation;
user input; or
application program input.

11. The non-transitory program storage device of claim 9, wherein said capturing and processing image with methods and parameters optimized for document images further comprises at least one procedure of:
segmentation of image;
enhancement of text;
enhancement of background;
automatic white balance optimized for documents;
local tone mapping optimized for documents;
flash and exposure adjustment optimized for documents; and
geometrical distortion correction.

12. The non-transitory program storage device of claim 10, wherein said automatic document classification further comprises:
obtaining camera orientation features;
obtaining camera distance features;
obtaining background features;
obtaining text features;
making classification decision based on at least one of said camera orientation, camera distance, background and text features.
